(19) United States
(12) Patent Application Publication
(10) Pub. No.: US 2019/0390106 A1
(43) Pub. Date: Dec. 26, 2019

(54) BIORENEWABLE RESIN COMPOSITION FOR WELL TREATMENT

(71) Applicant: Lawter, Inc., Chicago, IL (US)

(72) Inventor: Eva RAMOS, Beveren (BE)

(21) Appl. No.: 16/481,155

(22) PCT Filed: Jan. 23, 2018
(86) PCT No.: PCT/US2018/014858

§ 371 Date: Jul. 26, 2019

Related U.S. Application Data
(60) Provisional application No. 62/451,188, filed on Jan. 27, 2017.

(51) Int. Cl. C09K 8/80; C09K 8/20

(52) U.S. Cl. CPC C09K 8/805; C09K 8/203; C09K 2208/08; C09K 2208/04; C09K 8/206

(57) ABSTRACT

A proppant includes coating of a lignin containing phenolic resin. The proppants may be used in subterranean well formations and hydraulic fracturing operations.

### CROSS-REFERENCE TO RELATED APPLICATIONS

This application claims the benefit of priority to U.S. Provisional Patent Application No. 62/451,188, filed on Jan. 27, 2017, the entire contents of which are incorporated herein by reference.

### FIELD

The present technology is generally related to modified phenolic resins for coating proppants.

### BACKGROUND

Hydraulic fracturing is a technique commonly used to break open subterranean shale and rock formations to enhance the ease of extracting materials, most often oil and natural gas, from such formations. In this technique, water is mixed with sand and chemicals, and the mixture (“fracking fluid,” or “fracturing fluid”) is injected at high pressure into a wellbore to create small fractures.

Hydraulic fractures are formed by pumping the fracturing fluid into the wellbore at a rate sufficient to increase pressure downhole at the target zone. The rock cracks and the fracking fluid fills the cracks or fractures, extending the fracture. In order to maintain “fracture width” opened, or slow its closure, a material that includes a solid particle having sufficiently high crush strength, such as grains of sand, ceramic, or other particulates is introduced into the injected fluid. This material is referred to as a “proppant,” and it prevents the fractures from closing when the injection is stopped and the pressure of the fluid removed. It is the proppant that actually holds these fractures open or at least impedes the process of the cracks closing up after the fluid pressure is removed.

After the fracturing fluid has been pumped into the formation and the fracturing of the formation has been completed, it is often desirable to remove the fluid from the formation to allow hydrocarbon production through the new fractures. Generally, the removal of the highly viscous fracturing fluid is realized by “breaking” the gel or emulsion or, in other words, by converting the fracturing fluid into a low viscosity fluid. Breaking a gelled emulsified fracturing fluid has commonly been performed by adding a “breaker,” that is, a viscosity-reducing agent, to the subterranean formation at the desired time.

Proppants are designed to hold open the cracks in a formation for the life of the well, which is often from 5 to 45 years. Types of proppants include silica sand, resin-coated sand, ceramics and bauxite, among others. The most commonly used proppant is silica sand due to lower costs, though proppants of uniform size and shape, such as a ceramic proppants, may also be employed. The proppant pack may be permeable to oil or gas under high pressures, the interstitial space between particles of proppants may be sufficiently large and have the mechanical strength to withstand closure stresses and hold fractures open. The proppant is spherical, or nearly spherical to maximize the voids between particles, thereby allowing for a maximum flow of oil and gas past the proppant into the main portion of the well. The measure of how easily fluids can pass through a formation or through a proppant is known as its “conductivity.”

Untreated sand, when used as a proppant, is prone to generation of significant fines (i.e. finely ground sand) and flow-back, especially under higher formation stresses which could cause plugging of well opening and reducing conductivity. Synthetic resin coatings can be employed to maintain the proppant integrity when subjected to high pressures. Moreover, the coating makes the proppant resistant to chemical degradation and abrasion. Different synthetic resins may be used in proppant coatings including phenol resins, epoxy resins, polyurethane resins, furane resins, polyurea resins, and the like. In some coatings, the synthetic resin is completely cured when the coated proppant is placed into the well whereas for other applications the coating is partially cured during the coating process complete curing occurs when the proppant is placed in the well.

There are a number of concerns associated with the use of phenol-based resins due to the corrosive nature of phenol. Further, phenol and other aromatic alcohols are generally derived petroleum. It has also been determined that hexamethylenetetramine, which is often used to initiate the cure of phenolic resins, can be the cause of delays in fracturing fluid breaking. The production difficulties can include, for example, a diminished reduction in viscosity of the cross-linked gel, delaying production from the well. Other disadvantages of phenolic resins include the presence of water-soluble components, such as unreacted phenol or low molecular weight resin components.

There have been several proposed methods to minimize the problems associated with the use of phenolic resins. U.S. Pat. No. 5,218,038 describes the use of resole resins, which are not cured with hexamethylenetetramine.

U.S. Pat. No. 5,420,174 also describes the use of resole resin for coating proppants. Typically, resole resins are one-step resins. In other words, the resole resin self-polymerizes with increasing temperature and hexamethylenetetramine is not employed as the curing agent.

Despite these advances, there is still a need for effective phenolic resins with reduced problems. In addition, there is a demand for the use of more plant-derived materials, due to environmental concerns in the fracking process.

### SUMMARY

In one aspect the technology is directed to a composition including a particle and a coating on the particle, the coating including a lignin-containing phenolic resin where the composition is a proppant, and wherein the lignin-containing phenolic resin includes a polymerization product of at least one lignin, at least one aromatic alcohol, and at least one aldehyde.

The particle in the proppant may be any solid particle of adequate size that presents sufficiently high crush resistance. Suitable examples include, but are not limited to, sand, a naturally occurring mineral fiber, a ceramic, a bauxite, a glass, a metal bead, a walnut hull, or a composite particle. In some embodiments, the particle is a porous ceramic or porous polymer particle. In specific embodiments, the particle has a size from about 8 mesh to about 140 mesh, based on the U.S. Standard Sieve Series.

The lignin-containing phenolic resin comprises a polymerization product of at least one lignin, at least one aromatic alcohol, and at least one aldehyde. In some embodiments, the aromatic alcohol may be phenol, bifunctional phenol derivatives, trifunctional phenol derivatives, or tetrafunctional phenol derivatives. In some embodiments, the aromatic alcohol is a bifunctional phenol derivative, such as o-cresol, p-cresol, p-tert-butylphenol, p-phenylphenol, p-cumylphenol, p-nonylphenol, or 2,4- or 2,6-xylenol. In other embodiments, the aromatic alcohol is a trifunctional phenol derivative, such as m-cresol, resorcinol, and 3,5-xylenol. In further embodiments, the aromatic alcohol may be a tetrafunctional phenol derivative, such as bisphenol A and dihydroxy diphenylmethane. In other embodiments, the aromatic alcohol may be a halogenated aromatic alcohol.

In particular embodiments, the aromatic alcohol may be phenol. In other embodiments, the lignin-containing phenolic resin may include a mixture of aromatic alcohols.

In some embodiments, the aldehyde in the lignin-containing phenolic resin may be formaldehyde, paraformaldehyde, acetaldehyde, benzaldehyde, glutaraldehyde, trioxane, or tetraoxane. In specific embodiments, the aldehyde is formaldehyde or paraformaldehyde. In other embodiments, the lignin-containing phenolic resin may include a mixture of aldehydes.

In some embodiments, the lignin is a plant-derived lignin. In specific embodiments, the lignin may be derived from corn stover. In some embodiments, the lignin is a herbaceous plant-derived lignin. In some embodiments, the lignin is a grass, hardwood or softwood derived lignin.

In some embodiments, the lignin includes a carboxylic acid-modified lignin. In specific embodiments, the carboxylic acid-modified lignin is modified with a carboxylic acid including, but not limited to, acetic acid, propionic acid, butyric acid, lauric acid, and combinations thereof. In specific embodiments, the lignin is modified with acetic acid. In some embodiments, the lignin is an organosolv lignin or an acetosolv lignin.

In some embodiments, the lignin-modified phenolic resin includes more than about 4% or more than about 6% to less than about 80% or less than about 70% by mass of the lignin. In other embodiments, the lignin-modified phenolic resin includes more than about 10% to about 70% by mass of the aldehyde, compared to the total amount of the aromatic alcohol.

In some embodiments, the present technology is directed to a method of making a lignin-modified phenolic resin, by mixing at least one aromatic alcohol, at least one lignin, and at least one aldehyde, and optionally a catalyst, and heating the mixture.

In some embodiments, the at least one lignin is an unmodified lignin. In specific embodiments, the at least one lignin is a carboxylic acid modified lignin.

In some embodiments, the mixture of at least one aromatic alcohol, at least one lignin, and at least one aldehyde, and optional catalyst is heated to a temperature of about 50° C. to about 180° C. In some embodiments, the mixture of at least one aromatic alcohol, at least one lignin, and at least one aldehyde is reacted for about 0.5 hours to about 16 hours.

In some embodiments, the proppants of the present technology include from about 0.5% to about 8% by weight of the lignin-containing phenolic resin coating based on the weight of the uncoated particle.

In some embodiments, the reaction mixture for making a lignin-modified phenolic resin includes about 4% to about 80% by mass of lignin, relative to the amount of aromatic alcohols; about 10% to about 70% by mass of aromatic alcohols, relative to the total amount of lignin, aromatic alcohols, and aldehydes; and optionally, about 1 part to about 20 parts by mass of the catalyst.

In some embodiments, the aldehyde is added to the reaction “neat,” i.e., without being dissolved in a solvent. In other embodiments, the aldehyde is added to the reaction dissolved in a solvent. In specific embodiments, the aldehyde is dissolved in water. In further specific embodiments, the aldehyde is added as an aqueous solution having a concentration of about 10% by weight to about 80% by weight. In some embodiments, the reaction product of the lignins, aromatic alcohols, and aldehydes is purified by water washing.

In some embodiments, the present technology is directed to a fracking fluid, comprising a composition comprising: a particle; and a coating on the particle, the coating including a lignin-containing phenolic resin; wherein the composition is a proppant, and wherein the lignin-containing phenolic resin includes a polymerization product of at least one lignin, at least one aromatic alcohol, and at least one aldehyde.

In some embodiments, the fracking fluid further includes a corrosion inhibitor, a scale inhibitor, or a combination of any two or more thereof. In particular embodiments, the fracking fluid further includes one or more additives selected from the group consisting of acids, salts, friction reducers, agents to prevent formation of deposits, agents for maintaining fluid viscosity during temperature increases, agents for maintaining effectiveness of cross-linkers, bactericides, and viscosity enhancers.

In some embodiments, the present technology is directed to a method of preparing a proppant including a particle; and a coating on the particle, the coating including a lignin-containing phenolic resin; the method including contacting the particle with a composition including the lignin-containing phenolic resin.

In some embodiments, the particle, or the composition, or both, are heated to a temperature above the melting point of the resin. In further embodiments, the method includes cooling the hot-coated proppant to a temperature below the melting point of the resin.

In some embodiments, the composition including the lignin-modified phenolic resin further includes a solvent. In additional embodiments, the composition including the lignin-containing phenolic resin further includes a hardener in an amount from about 0.5% to about 40% by weight of the resin. In some embodiments, the hardener is hexamethylenetetramine, formaldehyde, paraformaldehyde, oxazolidines, phenolic resole resins, methylolmelamine, or methylolurea. In particular embodiments, the hardener is hexamethylenetetramine.

In further embodiments, the composition further includes a silane coupling agent, a plasticizer, a viscosity modifier, or a top coating, or combinations thereof.

In some embodiments, the method of coating the particle includes treating the particle with a coupling agent prior to contacting the particle with the composition including the lignin-containing phenolic resin. In some embodiments, the method of making the proppant applies a coating in an amount of from about 0.5% to about 8% by weight of the lignin-containing phenolic resin based on the weight of the uncoated particle.

### BRIEF DESCRIPTION OF THE DRAWINGS

FIG. 1 is an illustration of the crush resistance at 8000 psi of proppants coated with several resins, according to Example 4.

FIG. 2 is an illustration of the crush resistance at 5000 psi of proppants coated with several resins, according to Example 4.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In one aspect, the present technology is directed to proppants that may include a particle and a coating. In another aspect, the present technology is directed to a proppant coating. Without being bound by theory, it is believed that the proppant coatings enhance the performance characteristics of the proppant, for example, they provide good crush resistance and compressive strength, provide good conductivity of the proppant, and increase the biorenewable content when compared to traditional coated proppants. The resins of the present technology provide good properties, such as strength and toughness. Moreover, the resin-coated proppants of the present technology reduce the use of harmful raw materials such as phenol, preventing the associated health and environmental concerns.

The particle in the proppant may be any solid particle of adequate size that presents sufficiently high crush resistance. Suitable examples include, but are not limited to, a sand, a naturally occurring mineral fiber, a ceramic, a bauxite, a glass, a metal bead, a walnut hull, other nut shells, or a composite particle. In certain embodiments, the particle is a porous ceramic or porous polymer particle. In some embodiments, the particle has a mesh size from about 8 to about 140, based on the U.S. Standard Sieve Series.

Any type of material is suitable as a proppant, as long as the particle has sufficient strength to withstand the stresses, such as elevated temperature and pressure, often encountered in oil and gas recovery applications. In some embodiments, the particle of the coated proppant is a sand, a naturally occurring mineral fiber, a ceramic, a bauxite, a glass, a metal bead, a walnut hull, other nut shells, a composite particle, and the like. For instance, the sand can be graded sand. A ceramic can include both porous and non-porous ceramic materials, while a bauxite can include sintered bauxite materials. Composite particles are an agglomeration of smaller, fine particles held together by a binder, and such composite particles can be the particulate material in the present technology. Compositions containing coated proppants can employ mixtures or combinations of more than one type of particle, for instance, both a sand and a ceramic can be coated and then mixed to form a composition of coated proppants. Alternatively, a sand and a ceramic may be mixed and then coated to form a composition of coated proppants. It is contemplated that any particulate material suitable for use in proppant applications may be used in the present technology, regardless of the specific gravity of the particle, although it may be beneficial in certain applications to have a lower specific gravity to increase the distance that the proppants can be carried into a formation prior to settling.

In some embodiments, the particle is either a porous ceramic or porous polymer particle. Such particles are described in, for example, U.S. Pat. Nos. 7,426,961 and 7,713,918. These porous ceramic or porous polymer materials may be of natural origin or can be produced synthetically.

In some embodiments, the proppant includes a mixture of two or more different materials. For example, the proppant may include sand and ceramic beads at a ratio of from about 1:99 to about 99:1. In some embodiments, the proppant can include sand and ceramic beads at a ratio of about 90:10, about 80:20, about 70:30, about 60:40, about 50:50, about 40:60, about 30:70, about 20:80, or about 10:90. In some embodiments, part of the proppant is coated with the resin. For example, about 5%, about 10%, about 15%, about 20%, about 25%, about 30%, about 35%, about 40%, about 45%, about 50%, about 55%, about 60%, about 65%, about 70%, about 75%, or about 80% of the proppant is coated with the resin. In particular embodiments, the proppant includes about 85% raw (uncoated) sand, about 10% resin coated sand, and about 5% uncoated ceramic beads. All of the ratios and percentages indicated are by weight.

The particle size of the particle used in the coated proppant of the present technology generally falls within a range from about 100 microns to about 3000 microns (about 3 mm). In some embodiments, the particle size is from about 125 microns to about 2500 microns, from about 150 microns to about 2000 microns, or from about 175 microns to about 1500 microns. In some embodiments, the particle of the coated proppant of the present technology has a particle size that falls within a narrower range of about 200 to about 1000 microns, for example, about 250 to about 800 microns, or from about 300 to about 700 microns.

In some embodiments, the particles generally have a mesh size from about 8 to about 100, based on the U.S. Standard Sieve Series. For example, in a distribution of such particles that can be added to a treating fluid for use in a subterranean formation, at least about 90% by weight of the particles have a particle size falling within the range from about 8 to about 100 mesh. In accordance with another aspect of the present technology, at least about 95% by weight of the particles in a coated proppant composition have a size within the range from about 8 to about 100 mesh. Further, 90% by weight or more (e.g., 95% or more) of the particles in a coated proppant composition can have a size within the 20 to 40 mesh range in another aspect of this technology.

In some embodiments, the particle in the coated proppant has a size in the range from about 8 to about 140 mesh, from 10 to about 120 mesh, from about 10 to about 100 mesh, or from about 14 to about 80 mesh. In some embodiments, the particle is in a range from about 18 to about 60 mesh, or from about 20 mesh to about 40 mesh. In some embodiments, there is less than about 10% by weight, for example, 5% by weight of less, of particles in a coated proppant composition having a size of less than about 20 mesh or greater than about 50 mesh.

The use of a coated proppant has advantageous properties during the hydraulic fracturing process. The resin coating increases the effective compressive strength of the underlying proppant, such as sand, through the toughness of the resin. Upon being encased by the resin coating, the proppant becomes less brittle and has higher shear strength. Even if the proppant fails under pressure and breaks up in to smaller pieces, the resin coating encases the proppant and prevents the fines from becoming free. Even a small amount of loose fines in a proppant bed can significantly reduce the conductivity and thus the productivity of the well.

In one aspect, the technology is directed to proppants that may include a particle and a coating including a resin. In one aspect, the resin is a thermosetting resin. The thermosetting resin is not particularly limited and different thermosetting resins are known. In certain aspects, the thermosetting resin is a phenolic resin, epoxy resins, melamine resins, urea resins, unsaturated polyester resins, or urethane resins. In specific aspects, the phenolic resin is a phenolic novolac resin or a phenolic resole resin.

In specific embodiments, the thermosetting resin is a phenolic resin. Examples of phenolic resins include phenolic novolac resins or phenolic resole resins. Phenolic resins are generally prepared by the copolymerization of an aromatic alcohol (for example, phenol or substituted phenol) with an aldehyde. In certain embodiments, the phenolic thermosetting resin of the present technology may include lignin. In some aspects, the lignin is derived from different plant sources or production processes. In some embodiments, the lignin is a grass, hardwood, or softwood derived lignin. In some aspects, the lignin replaces a part of the phenol in the phenolic resin. In certain aspects, the resin is a reaction product of lignin, aromatic alcohols, and aldehydes. In some aspects, the lignin-containing phenolic resin may include unreacted functionalities that can further react in the well. In other aspects, the lignin-containing phenolic resin is completely cured before the fracking operation.

In some aspects, the aromatic alcohol employed in lignin-containing phenolic resins of the present technology is phenol or its derivatives. Examples of aromatic alcohols include, but are not limited to, phenol; bifunctional phenol derivatives such as o-cresol, p-cresol, p-tert-butylphenol, p-phenylphenol, p-cumylphenol, p-nonylphenol, and 2,4- or 2,6-xylenol; trifunctional phenol derivatives such as m-cresol, resorcinol, and 3,5-xylenol; and tetrafunctional phenol derivatives such as bisphenol A and dihydroxy diphenylmethane. In some embodiments, the resin includes halogenated aromatic alcohols. In specific embodiments, the halogenated aromatic alcohols include chlorine and bromine as halogens. In some aspects, a combination of one of more phenols can be employed in the resins of the present technology.

In some embodiments, the aldehydes employed in the lignin-containing phenolic resins of the present technology include, but are not limited to, formaldehyde, paraformaldehyde, acetaldehyde, benzaldehyde, glutaraldehyde, trioxane, and tetraoxane. In specific embodiments, the aldehyde is formaldehyde or paraformaldehyde. In some aspects, the aldehyde may include furfural, furfuryl alcohol, or the like. In some embodiments, a mixture of one or more aldehydes can be employed in the resins of the present technology.

In some embodiments, the molecular weight of the lignin-containing phenolic resin is greater than 1,000 g/mol. In some embodiments, the molecular weight of the lignin-containing phenolic resin is less than 100,000 g/mol. In some embodiments, the molecular weight of the lignin-containing phenolic resin is less than 50,000 g/mol. In some embodiments, the molecular weight of the lignin-containing phenolic resin is less than 30,000 g/mol. In some embodiments, the molecular weight of the lignin-containing phenolic resin is less than 20,000 g/mol.

Without being bound by theory, it is believed that the lignin-containing phenolic resins of the present technology may result in a resin coating with improved stability compared to phenolic resins.

In some embodiments, the lignin employed in the lignin-containing phenolic resins of the present technology is separated from the other lignocellulosic components of the plant by physical and/or chemical processes. In some embodiments, the lignin is modified or pre-treated. In specific embodiments, the modifications of the lignins employed in present technology include, but are not limited to, methylolation, phenolation, oxidation or oxypropylation. Typical commercially available technical lignins are derived from the paper industry. The lignins may be obtained as byproducts of any lignin producing process, such as the Kraft (Kraft lignin) or Sulfite (lignosulfonates) processes, which contain sulfur in their structure, or the soda process. Other characteristics of such lignins may include high carbohydrate content, impurities, ashes, relatively high molecular weight (particularly for lignosulfonates). In some embodiments, the lignin is an acetosolv or organosolv lignin. Generally, organosolv lignins are prepared by treatment of plant material with organic solvents, for example, ethanol. Without being bound by theory, it is believed that organosolv ligninreduces the formation of sulfated byproducts. In particular embodiments, the lignin is an acetosolv lignin, where acetic acid is employed as a solvent in the organosolv process.

In some embodiments, the lignins used in the lignin-containing phenolic resins of the present technology have a basic skeleton that is guaiacyl lignin (G type), syringyl lignin (S type), or p-hydroxyphenyl lignin (H type). See the structures below. In some embodiments, the lignins used in the lignin-containing phenolic resins of the present technology are derived from hardwoods, softwoods, or grasses, or other biomass sources. In other embodiments, the lignins used in the present technology are arboreous plant-derived lignins and herbaceous plant-derived lignins. Examples of the arboreous plant-derived lignins include lignins contained in softwoods and hardwoods. In specific embodiments, arboreous plant-derived lignins present low content of an H type monomer as a basic skeleton. In other embodiments, the lignins used in the present technology are softwood lignins having mainly G type as a basic skeleton or hardwood lignins having a G type and S type as the basic skeleton. In specific embodiments, the herbaceous plant-derived lignins include gramineous lignins contained in gramineous plants, including wheat straw, rice straw, corn, and bamboo. In specific embodiments, these herbaceous plant-derived lignins present H type, G type, and S type as the basic skeleton. In specific embodiments, a combination of two or more lignin types may be employed in the present technology.

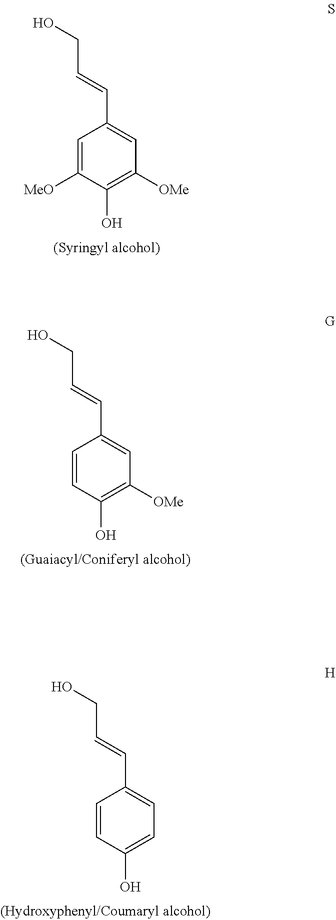 [SMILES: COc1cc(/C=C/CO)cc(OC)c1O ; COc1cc(/C=C/CO)ccc1O ; OC/C=C/c1ccc(O)cc1]

In some embodiments, the lignins of the present technology are processed by different processes including Kraft, sulfite, steam explosion or organosolv. In specific embodiments, a combination of two or more lignin types may be employed in the present technology.

In particular embodiments, the lignin employed in the present technology is a herbaceous plant-derived lignins. In specific embodiments, the herbaceous plant-derived lignins are obtained from corn stover (cobs, stalks, leaves, and the like). In further embodiments, the lignins employed in the present technology contain about 9 wt % or more of H type as the basic skeleton. In further specific embodiments, the lignins contain about 14 wt % or more of H type as the basic skeleton.

In some embodiments the lignin employed in the present technology is modified with a carboxylic acid group (“carboxylic acid-modified lignin”). A production process of a carboxylic acid-modified lignin is not particularly limited and can be based on a known method.

Examples of the carboxylic acid used in the production of carboxylic acid-modified lignin include carboxylic acids having one carboxyl group (“monofunctional carboxylic acid”). Specific examples include, but are not limited to, saturated aliphatic monofunctional carboxylic acids, unsaturated aliphatic monofunctional carboxylic acids, and aromatic monofunctional carboxylic acids. Examples of the saturated aliphatic monofunctional carboxylic acids include acetic acid, propionic acid, butyric acid, and lauric acid. Examples of the unsaturated aliphatic monofunctional carboxylic acids include acrylic acid, methacrylic acid, and linoleic acid. Examples of the aromatic monofunctional carboxylic acids include benzoic acid, 2-phenoxybenzoic acid, and 4-methylbenzoic acid. A combination of two or more monofunctional carboxylic acids may also be employed. In particular embodiments, the carboxylic acid is a saturated aliphatic monofunctional carboxylic acid. In a specific embodiment, the carboxylic acid is acetic acid. In some embodiments, the carboxylic acid-modified lignin has a higher solubility in organic solvents such as tetrahydrofuran, ethyl acetate, dimethyl sulfoxide, or dimethylformamide, compared to unmodified lignin. In other embodiments, the carboxylic acid modified lignin has a lower melting temperature compared to unmodified lignin.

In a particular embodiment, a carboxylic acid-modified lignin may be prepared by digesting a plant material (for example, softwood, hardwood, or gramineous plant) in the presence of a carboxylic acid and an inorganic acid (for example, hydrochloric acid or sulfuric acid).

In one embodiment, the amount of the carboxylic acid (in terms of 100%) added to the plant material is 500 parts by mass or more or 900 parts by mass or more and, 30,000 parts by mass or less or 15,000 parts by mass or less, each based on 100 parts by mass of the plant material which will become a raw material of the lignin.

In other embodiments, the amount of the inorganic acid (in terms of 100%) added to the plant material is 0.01 part by mass or more or 0.05 part by mass or more and 10 parts by mass or less or 5 parts by mass or less, each based on 100 parts by mass of the plant material which will be a raw material of the lignin.

In some embodiments, the reaction temperature of the raw material of the lignin and the acid mixture is suitable for the reaction to occur. In particular embodiments, the reaction temperatures include from about 30° C. to about 400° C. In further specific embodiments, the reaction temperature may include, but is not limited to a temperature from about 50° C. to 300° C., from about 100° C. to about 250° C., about 30° C. or more, 50° C. or more, about 400° C. or less, or about 250° C. or less. In some embodiments, the reaction time is suitable for reaction to occur. In specific embodiments, the reaction times may be 0.5 hour or more. In further specific embodiments, the reaction time is from about 0.5 hours to about 20 hours, or from about 0.5 hours to about 10 hours.

The reaction of a plant material with a carboxylic acid yields a reaction mixture, which may be separated by known techniques to yield a pulp and a filtrate (pulp waste liquor). In some embodiments, any unreacted carboxylic acid is removed by a method commonly used by those of skill in the art, for example, rotary evaporation or vacuum distillation. In specific embodiments, a large excess of water is added to precipitate the carboxylic acid-modified lignin, which may be filtered to obtain the carboxylic acid-modified lignin.

In other embodiments, a carboxylic acid-modified lignin may be prepared by reacting a lignin, which is not modified with a carboxylic acid (“unmodified lignin”), with a carboxylic acid. In some embodiments, the unmodified lignin may be in powder form. In specific embodiments, the unmodified lignin powder may have an average particle size of 0.1 μm or more or 5 μm or more and 1000 μm or less or 500 μm or less. In certain embodiments, the unmodified lignin powder may be obtained by drying and grinding the unmodified lignin by known methods. In other embodiments, a commercially available unmodified lignin powder may be used.

In some embodiments, the carboxylic acid modified lignin may be prepared by reaction between an unmodified lignin and a carboxylic acid. In some embodiments, the inorganic acid is hydrochloric acid or sulfuric acid, or other commonly known inorganic acids. In one embodiment, the amount of the carboxylic acid (in terms of 100%) added to the reaction is 300 parts by mass or more or 500 parts by mass or more and 15000 parts by mass or less or 10000 parts by mass, each based on 100 parts by mass of the unmodified lignin. In some embodiments, the amount of the inorganic acid (in terms of 100%) added is 0.01 part by mass or more or 0.05 part by mass or more and 10 parts by mass or less or 5 parts by mass or less, each based on 100 parts by mass of the unmodified lignin. In some embodiments, the reaction temperature is, for example, 30° C. or more or 50° C. or more and 400° C. or less or 250° C. or less. In some embodiments, the reaction time is, for example, 0.5 hour or more or 1 hour or more and 20 hours or less or 10 hours or less.

In some aspects, the carboxylic acid-modified lignins have greater solubility in an organic solvent and a lower melting temperature than an unmodified lignin. In some embodiments, in the organic solvent is a polar organic solvent including, but not limited to, acetone, methanol, phenol, tetrahydrofuran, acetonitrile, N-methylpyrrolidone, N,N-dimethylformamide, N,N-dimethylacetamide, dimethylsulfoxide, or hexamethyl phosphonyl amide). In some embodiments, the carboxylic acid modified lignin has a melting temperature of from about 100° C. to 200° C.

In some embodiments, the lignin-containing phenolic resins may be prepared by heating aromatic alcohol to an specific temperature, for example about 30° C. or more or about 40° C. or more, about 150° C. or less or about 130° C. or less. In some embodiments, the reaction mixture may include a solvent. In some embodiments, the solvent is a polar solvent, for example, water, ethanol or methanol. In other embodiments, the solvent may be toluene or xylene. The solvent may be employed based on the aromatic alcohol used.

In some embodiments, a catalyst may be added to the reaction. In specific embodiments, the catalyst may be a base or acid catalyst. Examples of base catalysts for phenolic resole resins include, but are not limited to, oxides and/or hydroxides of alkali earth metals, aliphatic amines such as dimethylamine, triethylamine, butylamine, dibutylamine, tributylamine, diethylenetriamine, and dicyandiamide; araliphatic amines such as N,N-dimethylbenzylamine; aromatic amines such as aniline and 1,5-naphthalenediamine; ammonia; naphthenic acids of divalent metals; and hydroxides of divalent metals. These basic catalysts may be used either singly or in combination. Examples of acid catalysts for phenolic novolac resins include, but are not limited to, oxalic acid, sulfuric acid, para-toluene sulfonic acid, zinc acetate, or other acidic agents commonly known to those skilled in the art. The mixing ratio of the basic or acid catalyst may be determined as needed, depending on the type of catalyst, the phenols, the aldehydes, and other reaction conditions. In some embodiments, the amount of the catalyst added is, for example, 1 part by mass or more or 1.5 parts by mass or more, and, for example, 20 parts by mass or less or 15 parts by mass or less, each based on 100 parts by mass of the phenol. In particular embodiments, the amount of catalyst is about 1% by weight, compared to the amount of aromatic alcohol. The timing of adding of the catalyst is not particularly limited. In some embodiments, the catalyst may be added in advance of at least any one of the lignin, the phenols, and the aldehydes; or the catalyst may be added simultaneously with the addition of the lignin, the aromatic alcohols, and the aldehydes; or the catalyst may be added to a mixture of the lignin, the phenols, and the aldehydes.

In some embodiments, a lignin is the added to the aromatic alcohols and catalyst mixture. Different lignin sources may be employed. In particular embodiments, the lignin is a carboxylic acid-modified lignin. In some embodiments, the amount of the lignin added is, for example, 4 mass % or more or 6 mass % or more, and, for example, 80 mass % or less or 70 mass % or less, compared to the total amount of the aromatic alcohols. In some embodiments, the amount of the aromatic alcohols added is, for example, 20 mass % or more or 25 mass % or more, and, for example, 90 mass % or less or 80 mass % or less, each based on the total amount of the lignin and the aromatic alcohols. In particular embodiments, about 40% of aromatic alcohol may be replaced by lignin. The lignin employed in the present technology may be unmodified. In other embodiments the lignin may be modified. Lignin chemical modifications are known by those skilled in the art and include, but are not limited to, methylolation, phenolation, and oxidation. In some embodiments, the modifications are in addition to carboxylation. Without being bound by theory, it is believed that these further modifications increase the reactivity of lignin with phenol and aldehydes.

In some embodiments, an aldehyde may be further incorporated into the mixture. In specific embodiments, the aldehyde is formaldehyde or paraformaldehyde. In some embodiments, the aldehyde may be added directly during making of the resin. In some embodiments, the aldehydes may be incorporated as a solid powder or as a solution. The amount and type of aldehydes depends on the type of phenolic resins (novolac or resole). The amount of the aldehydes added is, for example, about 10 mass % or more or about 20 mass % or more, and, for example, about 70 mass % or less or about 60 mass % or less, each based on the total amount of the lignin, aromatic alcohols, and aldehydes. In embodiments where the aldehyde is used as a solution, the aldehyde is dissolved in a suitable solvent. In specific embodiments, the aldehyde is used as an aqueous solution. In further embodiments, the concentration of the aldehydes in the solution is, for example, 10 wt % or more, or 20 wt % or more, and, for example, 80 wt % or less, or 70 wt % or less.

In some embodiments, the reaction mixture of the lignin, the aromatic alcohols, and the aldehydes is heated to a temperature of, for example, 50° C. or more or 60° C. or more, and, for example, 180° C. or less or 160° C. or less. The reaction time is, for example, 0.5 hour or more or 1 hour or more, and, for example, 16 hours or less or 14 hours or less.

In some embodiments, the reaction product of the lignins, aromatic alcohols, and aldehyde may be purified by water washing. The water wash may include the incorporation of water to the mixture at around 100° C. The ratio of the mass of water to the total mass of resin is 1:1 or more, 1.2:1 or more, or 3:1 or less. The water is contacted with the resin mixture for 2 minutes or more, 5 minutes or more, or 30 minutes or less. The water may be removed by decantation. In some embodiments, the water washing may be repeated at least 5 times. In some embodiments, the reaction product may be subjected to vacuum to remove the remaining water and unreacted phenol and/or formaldehyde. The vacuum may be applied at temperatures of 120° C. or more, 150° C. or more, 200° C. or less for a time period of 1 hour or more, 2 hours of more, 7 hours or less, or 6 hours or less.

The lignin-containing phenolic resin for proppant coating may exhibit a melting point that enables its use as a proppant coating. In some embodiments, the melting temperature is a temperature that is less than that employed during the coating procedure. In one aspect, the resin has a melting point from about 30° C. to about 200° C. In some embodiments, the melting point is from about 30° C., about 35° C., about 40° C., about 45° C., about 50° C., about 55° C., about 60° C., about 65° C., about 70° C., about 75° C., about 80° C., about 85° C., about 90° C., about 95° C., about 100° C., about 105° C., about 110° C., about 115° C., about 120° C., about 130° C., about 135° C., about 140° C., about 145° C., about 150° C., about 155° C., about 160° C., about 165° C., about 170° C., about 175° C., about 180° C., about 185° C., about 190° C., about 195° C., or about 200° C. In some embodiments, the melting point is from about 60° C. to about 100° C., or from about 100° C. to about 140° C., from about 140° C. to about 180° C., from about 180° C. to about 200° C. In some embodiments, the melting point is from about 80° C. to about 190° C. In some embodiments, the softening temperature of the lignin-containing resin is adequate for proppant coating purposes. In specific embodiments, the softening point of the lignin-containing resin is greater than 60° C., greater than 70° C., greater than 80° C., or less than 200° C., less than 180° C.

In some embodiments, the molecular weight of the lignin-containing phenolic resin is greater than 1,000 g/mol. In some embodiments, the molecular weight of the lignin-containing phenolic resin is less than 100,000 g/mol. In some embodiments, the molecular weight of the lignin-containing phenolic resin is less than 50,000 g/mol. In some embodiments, the molecular weight of the lignin-containing phenolic resin is less than 30,000 g/mol. In some embodiments, the molecular weight of the lignin-containing phenolic resin is less than 20,000 g/mol. In some embodiments, the lignin-containing phenolic resin is from about 1,000 g/mol to about 100,000 g/mol.

Methods of making coated proppants with the lignin-containing phenolic resins of the present technology are also provided. In one aspect, the technology is directed to a method of preparing a coated proppant, including contacting the proppant with a composition including a thermosetting resin. In some embodiments, the proppant and the composition include a lignin-containing phenolic resin. In some embodiments, the resin coating is applied onto a particle to obtain the coated proppant. For instance, the resin coating can be applied onto the particle using a warm or hot coat process in which the particles are first heated to a temperature above the melting point of the coating resin. The coating resin then is added to the hot particles, and mixed, causing the coating to fuse to the particles, thereby forming the coated proppant. Sufficient time is provided to allow the resin coating to thoroughly coat the particle, while blending or mixing of the particle with the resin coating is employed. For example, the resin coating is mixed with the particle for about 1 to 2 minutes. In some embodiments, the particle is mixed with the resin for up to about 5 minutes, up to about 6 minutes, up to about 7 minutes, up to about 8 minutes, up to about 9 minutes, or up to about 10 minutes.

The resin composition used to prepare the coated proppant may contain a hardener, depending on the type of the thermosetting resin. In specific embodiments, when a phenolic novolac resin is used as the thermosetting resin, the resin composition may contain a phenolic novolac resin hardener. The phenolic resin hardener is not particularly limited and different known hardeners may be used. Specific examples include hexamethylenetetramine, formaldehyde, paraformaldehyde, oxazolidines, phenolic resole resins, methylolmelamine, and methylolurea. In a particular embodiment, the phenolic novolac resin hardener is hexamethylenetetramine. The hardener is added to the proppant and resin mixture in an appropriate ratio and reacted for sufficient time.

In one aspect, the weight percent of the hardener based on the weight of the lignin-containing phenolic novolac resin coating is from about 0.5% to about 40% by weight of resin. In some embodiments, the weight percent may be about 1%, about 5%, about 15%, about 20%, about 25%, about 30%, about 35%, or about 40%. In some embodiments, the weight percent may be within any range from about 0.5% to about 40%, from about 5% to about 35%, or from about 10% to about 30%. In particular embodiments, the weight percent is about 10% to about 25%. The resin and proppant mixture is reacted with the hardener for about 1 to 4 minutes. In some embodiments, the particle is mixed with the resin for up to about 5 minutes, up to about 6 minutes, up to about 7 minutes, up to about 8 minutes, up to about 9 minutes, or up to about 10 minutes.

In some embodiments, the hot-coated proppant is then cooled to a temperature below the melting point of the coating resin. In some embodiments, the method of preparing a coated proppant results in a free-flowing, non-tacky coated proppant. The coated proppants may be sieved to the desired particle size distribution.

In one aspect, the weight percent of the resin coating based on the weight of the uncoated particle is from about 0.5% to about 8% by weight of the particle. In some embodiments, that the weight percent can be about 1%, about 1.5%, about 2%, about 2.5%, about 3%, about 3.5%, about 4%, about 4.5%, about 5%, about 5.5%, about 6%, about 6.5%, about 7%, about 7.5%, or about 8%. In some embodiments, the weight percent can be within any range from about 1% to about 8%, from about 2% to about 7%, from about 3% to about 6%, from about 4% to about 6%, from about 2% to about 8%, or from about 1% to about 5%. In particular embodiments, the weight percent is about 0.5% to about 4%.

In one aspect, the coating formulation to coat the resin on to the particle includes suitable additives. Suitable additives include, but are not limited to, silane coupling agents, plasticizers, fillers, viscosity modifier, top-coatings, antistatic agents, anticaking agents, wetting agents or combinations thereof. In some embodiments, the coating formulation includes a viscosity modifier to facilitate easy, efficient, and uniform coating of the particle. In some embodiments, the plasticizer, the viscosity modifier, or combinations thereof, are cross-linked to each other or to the lignin-containing phenolic resin, individually or together.

In one aspect, the particle is treated with a coupling agent prior to its treatment with the composition including the lignin-modified phenolic resin. Without being limited by theory, it is hypothesized that the coupling agent helps bond the resin coating to the proppant surface. In some embodiments, the coupling agent is a silane coupling agent. Functional silanes such as aminosilanes, epoxy- aryl- or vinyl silanes are commercially available. Examples of silane coupling agents include, but are not limited to, acrylate and methacrylate functional silanes such as (3-acryloxypropyl) trimethoxy-silane, methacryloxypropyl trimethoxy-silane, methacryloxymethyl trimethoxy silane, (3-acryloxypropyl) methyldimethoxy silane, methacryloxypropyl dimethylethoxy-silane, aldehyde functional silanes such as triethoxysilylundecanal, triethoxsilylbutyraldehyde, epoxy functional silanes such as 2-(3,4-epoxycyclohexyl) ethyl-triethoxy silane, 2-(3,4-epoxycyclohexyl) ethyl-trimethoxy silane, (3-glycidoxypropyl) triethoxy silane, (3-glycidoxypropyl) methyldiethoxy-silane, (3-glycidoxypropyl) dimethylethoxy silane, ester functional silanes such as acetoxymethyl triethoxysilane, acetoxymethyl trimethoxysilane, acetoxypropyl trimethoxysilane, 10-(carbomethoxy) decyldimethyl-methoxysilane, isocyanate functional silanes such as 3-isocyanato propyl triethoxysilane, 3-isocyanato propyl trimethoxysilane, triethoxysilyl propylethyl carbamate, 3-thiocyanatopropyl triethoxysilane.

Without being bound by theory, it is hypothesized that the coated proppant exhibits adequate crush resistance and conductivity, and is non-tacky and free-flowing after coating and during transport and storage. Without being bound by theory, it is also hypothesized that the coating has minimal interference with the fracking fluid composition. In addition, the proppants of the present technology are coated with a resin containing biorenewable raw materials without compromising the performance of the proppant.

In another aspect, the technology is directed to a fracking fluid including a coated proppant, which may include a particle and a coating comprising a lignin-containing phenolic resin as described herein. In some embodiments, the fracking fluid may include water. The fracking fluid may further include one or more additives such as, but not limited to, corrosion inhibitors or scale inhibitors, wetting agents, surfactants or a combination of any two or more thereof.

In some embodiments, the fracking fluid includes additives that can serve other benefits to maximize flow out of the formation or minimize damage to equipment that is placed in the formation or equipment that is used to extract the oil and gas from the formation (pumps, etc.). Use of such additives may reduce the cost of fracking fluids and the cost of fluids that have to be added to the well during oil and gas extraction. Examples of additives in the fracking fluid include acids such as hydrochloric or acetic acid; salts such as sodium chloride; friction reducers such as polyacrylamide; ethylene glycol, which prevents the formation of deposits in the pipe; agents for maintaining fluid viscosity during temperature increases, such as borate salts; agents for maintaining effectiveness of cross-linkers, such as sodium or potassium carbonates; bactericides, such as glutaraldehyde; viscosity enhancers, such as water soluble gelling agents to increase the viscosity of the fracking fluid to deliver the proppant more efficiently into the formation; corrosion prevention agents such as citric acid; and viscosity enhancers such as isopropanol. In some embodiments, combinations of various additives are added to the fracking fluid to achieve the desired properties.

The present technology also includes the use of the coated proppants described herein in conjunction with a fracturing liquid to increase the production of petroleum or natural gas. Techniques for fracturing an unconsolidated formation that include injection of consolidating fluids are also well known in the art. See U.S. Pat. No. 6,732,800, the disclosure of which is herein incorporated by reference. Generally, a fluid is injected through the wellbore into the formation at a pressure less than the fracturing pressure of the formation. The volume of consolidating fluid to be injected into the formation is a function of the formation pore volume to be treated and the ability of the consolidating fluid to penetrate the formation and can be readily determined by one of ordinary skill in the art. As a guideline, the formation volume to be treated relates to the height of the desired treated zone and the desired depth of penetration, and the depth of penetration in some embodiments is at least about 30 cm radially into the formation.

Before consolidating the formation, optionally, an acid treatment may be performed by injection of an acidic fluid. The acidic treatment typically may include several stages such as an acid pre-flush, one or more stages of acid injection and an over-flush.

After the perforation and the consolidation, the final step is the fracturing step. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. In order to maintain the fractures formed in the formation after the release of the fluid pressure, the fracturing fluid carries a proppant whose purpose is to prevent the fracturing from closing after pumping has been completed.

The fracturing liquid is not particularly restricted and can be selected from among the fracking liquids known in the specific field. Suitable fracturing liquids are described, for example, in W C Lyons, G J Plisga, Standard Handbook Of Petroleum And Natural Gas Engineering, Gulf Professional Publishing (2005). The fracturing liquid can be, for example, water gelled with polymers, an oil-in-water emulsion gelled with polymers, or a water-in-oil emulsion gelled with polymers.

The present technology relates to a method for the production of petroleum or natural gas which comprises the injection of the coated proppant into the fractured stratum with the fracturing liquid, i.e., the injection of a fracturing liquid which contains the coated proppant, into a petroleum- or natural gas-bearing rock layer, and/or its introduction into a fracture in the rock layer bearing petroleum or natural gas. The method is not particularly restricted and can be implemented in the manner known in the specific field.

The present technology, thus generally described, will be understood more readily by reference to the following examples, which are provided by way of illustration and are not intended to be limiting of the present invention.

### EXAMPLES

### Example 1

Production of Acetic Acid-Modified Lignin: Corn stover (100 parts by mass) was mixed with 1,000 parts by mass of 95 mass % acetic acid and 3 parts by mass of sulfuric acid. The resulting mixture was allowed to react for 4 hours under reflux. After the reaction, the reaction mixture thus obtained was filtered to remove pulp and collect a pulp waste liquor. Then, acetic acid was removed from the pulp waste liquor by using a rotary evaporator. After concentration to reduce its volume to 1/10, water was added to the concentrate in an amount 10 times the concentrate (on a mass basis), followed by filtration to obtain an acetic acid-modified lignin as a solid component. Part of the lignin was separated from the pulp waste liquor by employing an organic solvent (ethyl acetate) before the filtration. The lignin soluble in the organic solvent will be referred as “soluble carboxylic acid-modified lignin” (CS) and the lignin that was not soluble in the organic solvent will be referred as “insoluble carboxylic acid-modified lignin” (CI).

### Example 2

Preparation of an Exemplary Resin Composition: A 0.5 L three-necked flask equipped with a reflux condenser tube, a thermometer and a stirrer, was charged with 120-205 g of phenol at a temperature of 50° C. Next, 0-75 g (corresponding to 0-53 g with respect to 100 g of the phenol) of the acetic acid-modified lignin (CS or CI) obtained in Example 1 was added thereto at 50° C. to be stirred. Next, 28-42 g of paraformaldehyde was added thereto. The molar formaldehyde/phenol ratio of the different resins were kept constant at 0.61, taking into account the total amount of the phenolic hydroxyl group of the acetic acid-modified lignin and the phenolic hydroxyl group of the phenol. Oxalic acid at 1 wt % of the total mass of raw materials was added as an acid catalyst and the obtained mixture was stirred to be uniform.

The temperature was gradually increased (over about one hour) to reach 95° C. and the obtained mixture was allowed to react at 80° C. for three hours. Then, the mixture was heated to 110° C. and maintained at that temperature for two hours. The mixture is then heated to 120° C. and reaction continued for about 1.5 hours. Upon completion of the reaction, 300 mL of boiling water was added to the reactor for the water washing step and the reaction mixture separated for decantation. This process was repeated five times. Upon completion of the water washing step, the mixture was heated to 150° C. and the excess of water was removed. Vacuum was then applied for 2-3 hours, and a lignin-containing novolac phenolic resin as a reaction product was obtained.

### Example 3

Preparation of an Exemplary Resin Composition Using Phenolated Lignin: A 0.5 L three-necked flask equipped with a reflux condenser tube, a thermometer and a stirrer was charged with 120-205 g of phenol at a temperature of 50° C. Next, 1-75 g (corresponding to 0.5-53 g with respect to 100 g of the phenol) of the acetic acid-modified lignin (CS or CI) obtained in Example 1 was added thereto at 50° C. and stirred. Oxalic acid was then added as an acid catalyst at 1 wt % of the total mass of raw materials and the obtained mixture was stirred to be uniform. The temperature was gradually increased (over about one hour) to reach 130° C. and the obtained mixture maintained at 130° C. for one hour. Without being bound by theory, it is believed that the addition of the oxalic acid and heating results in phenolation of the carboxylated lignin.

The temperature was then decreased to 100° C. and 28-42 g of paraformaldehyde was added to the reaction mixture. The molar formaldehyde/phenol ratio of the different resins were kept constant at 0.61, taking into account the total amount of the phenolic hydroxyl group of the acetic acid-modified lignin and the phenolic hydroxyl group of the phenol. The temperature of the mixture was gradually increased (over about one hour) to reach 95° C. and the obtained mixture maintained at 95° C. for three hours. Next, the mixture was heated to 110° C. and reacted for two hours. The temperature was then raised to 120° C. and reacted for about 1.5 hours. Upon completion of the reaction, 300 mL of boiling water was added to the reactor for the water washing step and is the mixture separated for decantation. This process was repeated five times. Upon completion of the water washing step, the mixture was heated to 150° C. and the excess of water was removed. Vacuum was applied for about 2-3 hours, and a modified lignin-containing novolac phenolic resin as a reaction product was obtained.

The composition of the resins obtained in Examples 2 and 3 and their properties are shown in Table 1.

TABLE 1
Compositions of Examples 2 and 3.

| Resin | A | B | C | D | E | F | G |
|---|---|---|---|---|---|---|---|
| Lignin (wt %) * | 10.0 | 20 | 30.0 | 10.0 | 10 | 30 | 10 |
| Lignin's type | CS | CS | CS | CI | CS | CS | CI |
| Phenolation | N | N | N | N | Y | Y | Y |
| Formaldehyde/phenol ratio | 0.64 | 0.61 | 0.60 | 0.62 | 0.63 | 0.62 | 0.64 |

Final properties

| | | | | | | | |
|---|---|---|---|---|---|---|---|
| Softening point (° C.) | 102.6 | 108.9 | 129.7 | 97.8 | 108.5 | 126.8 | 107.3 |
| Melt viscosity (mPa · s) @ | 280 | 680 | 3290 | 245 | 470 | 3100 | 560 |
| 170° C., 50 rpm | | | | | | | |
| Mw | 1639 | 3238 | 6902 | 2079 | 2123 | 6115 | 2550 |

* Refers to total amount of raw materials

### Example 4

Production and characterization of resin coated sand: Resins obtained in Examples 2 and 3 and a commercial sample (Plenco 14542, SP=101 C, Mw=3400 g/mol) were employed to coat sand (20-40 mesh). The sand (100 g) was heated to 200° C. and the resin (6 g) was added and mixed for 2 minutes. A hardener (3 g, hexamethylenetetramine in a 30 wt % aqueous solution) was added to the sand resin mixture and reacted for 4 minutes. The Resin-Coated Sand (“RCS”) was cooled down and sieved.

Properties of the RCS batches obtained are summarized in the Table 2.

TABLE 2
RCS Batches

| | | | | | | Acid |
|---|---|---|---|---|---|---|
| | | Lignin | Lignin | | Coating | solubility |
| Batch | Resin | type | (wt %*) | Phenolation | weight | (%) |
| RCS-1 | Plenco | — | — | — | 3.55 | 0.41 |
| | 14542 | | | | | |
| RCS-2 | A | CS | 10 | N | 3.60 | 0.29 |
| RCS-3 | B | CS | 20 | N | 3.43 | 0.30 |
| RCS-4 | C | CS | 30 | N | 3.84 | 0.34 |
| RCS-5 | D | CI | 10 | N | 3.44 | 0.40 |
| RCS-6 | E | CS | 10 | Y | 3.75 | 0.60 |
| RCS-7 | G | CI | 10 | Y | 3.57 | 0.71 |

*Refers to total amount of raw materials

The total coating weight was determined by means of thermogravimetric analysis (TGA) analysis whereas the acid solubility was measured following the test procedure described in “Measurements of Properties of Proppants used in Hydraulic Fracturing and Gravel-packing Operations, ANSI/API recommended practice 19C. ISO 13503-2:2006”.

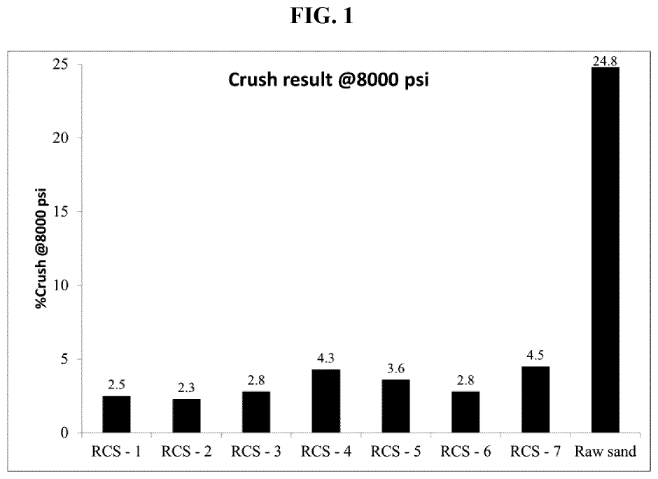

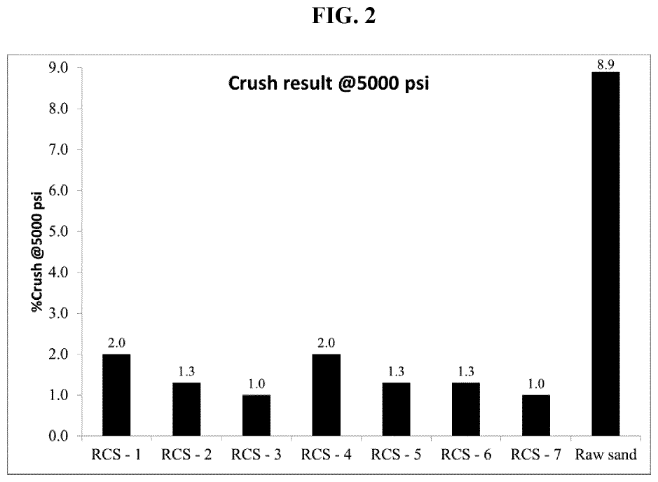

Coated proppants were prepared and characterized as described in Example 4. The graphs in FIGS. 1 and 2 illustrate the Crush Resistance results of four samples coated with the commercial sample Plenco 14542 and the resins developed in Examples 2 and 3 at 5000 and 8000 psi. The test procedure described in “Measurements of Properties of Proppants used in Hydraulic Fracturing and Gravel-packing Operations, ANSI/API recommended practice 19C. ISO 13503-2:2006” was followed to conduct the tests.

As seen in FIGS. 1 and 2 several RCS demonstrate better or equal performance compared to commercial phenolic samples at 5,000 psi. At 8,000 psi, the performance of the lignin-containing phenolic resin coated sands of the present technology is comparable to the commercial sample. All the coated samples show better performance than the uncoated sand.

Para. A. A composition comprising:

a particle; and

a coating on the particle, the coating comprising a lignin-containing phenolic resin;

wherein:
the composition is a proppant, and
the lignin-containing phenolic resin comprises the polymerization product of at least one lignin, at least one aromatic alcohol, and at least one aldehyde.

Para. B. The composition of Para. A, wherein the particle is a sand, a naturally occurring mineral fiber, a ceramic, a bauxite, a glass, a metal bead, a walnut hull, or a composite particle.

Para. C. The composition of Para. A or B, wherein the particle is a porous ceramic or porous polymer particle.

Para. D. The composition of any of Paras. A-C, wherein the particle has a size from about 8 mesh to about 140 mesh.

Para. E. The composition of any one of Paras. A-D, wherein the aromatic alcohol is selected from the group consisting of phenol, bifunctional phenol derivatives, trifunctional phenol derivatives, and tetrafunctional aromatic alcohol derivatives.

Para. F. The composition of Para. E, wherein the aromatic alcohol is a bifunctional phenol derivative selected from the group consisting of o-cresol, p-cresol, p-tert-butylphenol, p-phenylphenol, p-cumylphenol, p-nonylphenol, and 2,4- or 2,6-xylenol.

Para. G. The composition of Para. E, wherein the aromatic alcohol is a trifunctional phenol derivative selected from the group consisting of m-cresol, resorcinol, and 3,5-xylenol.

Para. H. The composition of Para. E, wherein the aromatic alcohol is a tetrafunctional phenol derivative selected from the group consisting of bisphenol A and dihydroxy diphenylmethane.

Para. I. The composition of any one of Paras. A-H, wherein the aromatic alcohol is a halogenated aromatic alcohol.

Para. J. The composition of any one of Paras. A-D, wherein the aromatic alcohol is phenol.

Para. K. The composition of any one of Paras. A-J, wherein the aldehyde is selected from the group consisting of formaldehyde, paraformaldehyde, acetaldehyde, benzaldehyde, glutaraldehyde, trioxane, and tetraoxane.

Para. L. The composition of Para. K, wherein the aldehyde comprises formaldehyde or paraformaldehyde.

Para. M. The composition of any one of Paras. A-L, wherein the lignin is a plant-derived lignin.

Para. N. The composition of any one of Paras. A-M, wherein the lignin is a hardwood, softwood, or grass derived lignin or other biomass source.

Para. O. The composition of any one of Paras. A-N, wherein the lignin comprises a carboxylic acid-modified lignin.

Para. P. The composition of Para. O, wherein the carboxylic acid-modified lignin is modified with a carboxylic acid selected from the group consisting of acetic acid, propionic acid, butyric acid, lauric acid, and combinations thereof.

Para. Q. A method of making a lignin-modified phenolic resin, comprising mixing at least one aromatic alcohol, at least one lignin, and at least one aldehyde, and optionally a catalyst, and heating the mixture.

Para. R. The method of Para. Q, wherein the at least one lignin is an unmodified lignin.

Para. S. The method of Para. Q, wherein the at least one lignin is a carboxylic acid modified lignin.

Para. T. A fracking fluid, comprising a composition comprising:

a particle; and

a coating on the particle, the coating comprising a lignin-containing phenolic resin;

wherein:
the composition is a proppant, and
the lignin-containing phenolic resin comprises the polymerization product of at least one lignin, at least one aromatic alcohol, and at least one aldehyde.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

While certain embodiments have been illustrated and described, it should be understood that changes and modifications can be made therein in accordance with ordinary skill in the art without departing from the technology in its broader aspects as defined in the following claims.

1. A composition comprising:
a particle; and
a coating on the particle, the coating comprising a lignin-containing phenolic resin;
wherein:
the composition is a proppant, and
the lignin-containing phenolic resin comprises the polymerization product of at least one lignin, at least one aromatic alcohol, and at least one aldehyde.

2. The composition of claim 1, wherein the particle is a sand, a naturally occurring mineral fiber, a ceramic, a bauxite, a glass, a metal bead, a walnut hull, or a composite particle.

3. The composition of claim 1, wherein the particle is a porous ceramic or porous polymer particle.

4. The composition of claim 1, wherein the particle has a size from about 8 mesh to about 140 mesh.

5. The composition of claim 1, wherein the aromatic alcohol is selected from the group consisting of phenol, bifunctional phenol derivatives, trifunctional phenol derivatives, and tetrafunctional aromatic alcohol derivatives.

6. The composition of claim 5, wherein the aromatic alcohol is a bifunctional phenol derivative selected from the group consisting of o-cresol, p-cresol, p-tert-butylphenol, p-phenylphenol, p-cumylphenol, p-nonylphenol, and 2,4- or 2,6-xylenol.

7. The composition of claim 5, wherein the aromatic alcohol is a trifunctional phenol derivative selected from the group consisting of m-cresol, resorcinol, and 3,5-xylenol.

8. The composition of claim 5, wherein the aromatic alcohol is a tetrafunctional phenol derivative selected from the group consisting of bisphenol A and dihydroxy diphenylmethane.

9. The composition of claim 5, wherein the aromatic alcohol is a halogenated aromatic alcohol.

10. The composition of claim 5, wherein the aromatic alcohol is phenol.

11. The composition of claim 1, wherein the aldehyde is selected from the group consisting of formaldehyde, paraformaldehyde, acetaldehyde, benzaldehyde, glutaraldehyde, trioxane, and tetraoxane.

12. The composition of claim 11, wherein the aldehyde comprises formaldehyde or paraformaldehyde.

13. The composition of claim 1, wherein the lignin is a plant-derived lignin.

14. The composition of claim 1, wherein the lignin is a hardwood, softwood, or grass derived lignin or other biomass source.

15. The composition of claim 1, wherein the lignin comprises a carboxylic acid-modified lignin.

16. The composition of claim 15, wherein the carboxylic acid-modified lignin is modified with a carboxylic acid selected from the group consisting of acetic acid, propionic acid, butyric acid, lauric acid, and combinations thereof.

17. A method of making a lignin-modified phenolic resin, comprising
mixing at least one aromatic alcohol, at least one lignin, and at least one aldehyde, and optionally a catalyst, and
heating the mixture.

18. The method of claim 17, wherein the at least one lignin is an unmodified lignin.

19. The method of claim 17, wherein the at least one lignin is a carboxylic acid modified lignin.

20. A fracking fluid, comprising a composition comprising:
a particle; and
a coating on the particle, the coating comprising a lignin-containing phenolic resin;
wherein:
the composition is a proppant, and
the lignin-containing phenolic resin comprises the polymerization product of at least one lignin, at least one aromatic alcohol, and at least one aldehyde.
